(19) United States
(12) Patent Application Publication
(10) Pub. No.: US 2013/0173344 A1
(43) Pub. Date: Jul. 4, 2013

(54) SYSTEM FOR IMPLEMENTING PLURALITY OF INTERACTIVE SERVICES ASSOCIATED WITH FINANCIAL ORGANIZATION

(71) Applicants: Chandramouli Kundagrami, Bangalore (IN); Arunnima Balakrishnan Senakumari, Thiruvananthapuram (IN)

(72) Inventors: Chandramouli Kundagrami, Bangalore (IN); Arunnima Balakrishnan Senakumari, Thiruvananthapuram (IN)

(73) Assignee: Infosys Limited, Bangalore, Karnataka (IN)

(21) Appl. No.: 13/813,294

(22) PCT Filed: Jul. 30, 2010
(86) PCT No.: PCT/IN2010/000509

§ 371 Date: Feb. 28, 2013

(51) Int. Cl. G06Q 30/02; G06Q 50/00

(52) U.S. Cl. CPC G06Q 30/0201; G06Q 50/01
USPC 705/7.32; 705/39; 705/7.29

(57) ABSTRACT

Disclosed is an integrated system for implementing various interactive services for a plurality of users associated with a financial organization. The system includes a linking module and a function module. The linking module associates user profiles corresponding to each of the users with the financial organization to enable the services for the users. The function module enables the users to perform a plurality of functionalities associated with the financial organization. Each of the users is enabled to perform the functionalities based on a type of user profile corresponding to the each of the users. Further, the function module includes a transaction module, an interaction module, and a social networking module. The transaction module, the interaction module, and the social networking module enable the users to utilize transaction services, interactive services, and social networking services, respectively.

### FIELD OF THE INVENTION

The present invention relates generally to the field of Web based financial solutions and, more particularly, to the field of providing interactive solutions associated with a financial organization through various communication channels.

### BACKGROUND

Every business aims to achieve utmost client satisfaction while enhancing its business goals. Financial organizations such as banks are primarily focused on meeting customer demands by offering various services. However, it is impossible for any financial organization to cater to each and every customer's need.

Over time, many service areas associated with the financial organizations have been improved and customized to meet customer demands. For instance, some financial organizations have adopted a step-by-step approach for bringing in qualitative changes in their service offerings. However, such services and offerings still require customers to convey their requests or clarify their queries with the financial organizations through various communication media. Also, the financial organizations usually take substantial time and effort in understanding the customers' requests and queries and in subsequent processing thereof.

Further improvements in service offerings also include the development of various Web solutions (such as one or more websites of the financial organizations) for the customers to access various online services and/or products' characteristics. However, some customers' requirements may require individual attention from the financial organizations. For this, either the financial organization or the customers will have to follow up with each other personally.

Also, as customers become more Web literate, they prefer to perform their own research regarding the services and/or products from other customers of a financial organization. Nowadays, some tech savvy customers prefer to research online about services and products that may suit their requirements before making any decision to buy a particular service/product of the financial organization. A customer may research further to know currently available services and/or products from other financial organizations, view detailed product catalogues and comparisons, view online demos, other customers' experiences, latest information about the services offerings of the financial institutions, and the like. Based on the research, the customers may decide either to opt for the services and/or products or to switch for a better option. However, for such research the customers may be required to visit a branch office of the financial organizations, communicate through telephonic means, or access information through multiple websites. Hence, to obtain sufficient information, the customers need to spend their time, effort, and cost.

Based on the foregoing discussion, there is a need for an integrated system for providing a plurality of services associated with the financial organizations to the customers in an easy way. The system should also provide the customers with readily available information to conduct research about various products/services of the financial organizations. Further, the system should provide means for providing individual attention to the customers and their queries. Furthermore, there is a need for providing various means to allow the customers to interact with other members of the customers' community, social group members, and financial organization representatives for conducting their researches about the financial organizations and products/services offerings thereof. The customers should be able to reuse the results of research conducted by other customers and form their own opinions by seeking those of other customers in a similar profile as a part of their research exercise. The system should also allow the financial organizations to market their services and/or products with ease.

### SUMMARY

The present invention provides an integrated system for implementing a plurality of Web 2.0 type of interactive services associated with a financial organization. The services are implemented for a plurality of users. The system includes a linking module and a function module. The linking module associates user profiles corresponding to each of the plurality of users with the financial organization to enable the plurality of services for the plurality of users. The function module enables the users to perform a plurality of functionalities associated with the financial organization. Each of the users is enabled to perform the functionalities based on a type of user profile corresponding to the each of the users associated with the financial organization. Further, the function module includes a transaction module, an interaction module, and a social networking module. The transaction module enables the plurality of users to utilize one or more transaction services of the plurality of services. Similarly, the interaction module enables the plurality of users to utilize one or more interactive services, and the social networking module enables the plurality of users to utilize one or more social networking services of the plurality of services.

The users may be capable of accessing these services based on the type of association they share with the financial organization. The services may include transaction services, interaction services, and social networking services that may allow the user to perform numerous functionalities based on the type of association of the user with the financial organization.

The integrated system described above has numerous advantages. For example, some services deployed over the system may enable the users to interact with registered users, such as customers of the financial organization, employees of the financial organization, and with non-registered users such as users of social networking websites. Further, the system may provide various features for the users that may enable them to perform the research corresponding to a particular service offered by the financial organization. This may further assist the users in deciding a particular service of the financial organization. Furthermore, the system may enable the users to recommend any of the services and/or products, associated with the financial organization, to their social groups through various social networking websites. Additionally, the user, who can also be an employee of the financial organization, may interact with any of the customers of the financial organization. This may enable the employee to conduct/participate in surveys and perform other functionalities for the financial organization. Thus, the system provides an integrated platform for a user with a plethora of services to be availed.

Additionally, financial organizations may take various strategic actions based on the functionalities performed by the users. For this, the system may be used to analyze the social behavior of the users; for example, within the banking website, which can be analyzed for understanding the needs of the customers. For instance, the users may rate services offered by the bank. Thereafter, the bank may improve the quality of services or introduce a service based on the rating. Thus, the system may provide a module to analyze the rating and generate a report based thereon.

### BRIEF DESCRIPTION OF THE DRAWINGS

The various embodiments of the invention will hereinafter be described in conjunction with the appended drawings, provided to illustrate, and not to limit, the invention, wherein like designations denote like elements, and in which:

FIG. 1 illustrates an interactive environment in which various embodiments of the invention may be practiced;

FIG. 2 illustrates a block diagram of a system to implement a plurality of services associated with a financial organization, in accordance with an embodiment of the invention;

FIG. 3 illustrates a block diagram for a plurality of services associated with a financial organization, in accordance with an embodiment of the invention; and

FIG. 4 illustrates a block diagram for exemplary social networking service, in accordance with an embodiment of the invention.

### DETAILED DESCRIPTION OF THE INVENTION

The present invention comprises a system that may be utilized in an interactive environment (hereinafter referred to as “environment”). The environment may include, but is not limited to, a plurality of users, a plurality of financial organizations, a server, social network, and a communication channel. Hereinafter, the plurality of users and the plurality of financial organizations are referred to as “users” and “financial organizations”, respectively. The communication channel may include, but is not limited to, the Internet, intranet, Local Area Network (LAN), Wide Area Network (WAN), Metropolitan Area Network (MAN), and wired or wireless networks.

The environment may enable linking of one or more financial organizations with the server to provide various Web 2.0 features to users associated with the financial organization. These features may include, but are not restricted to, wikis, blogs, Really Simple Syndication feeds (RSS feeds), various widgets, online discussion forums, online demos, accessing online communities such as social groups. This enables the users to avail numerous services and to interact among themselves and with the financial organizations.

In accordance with various embodiments of the invention, users may include customers associated with a financial organization, employees of the financial organization, and representatives of one or more “other” financial organizations. Here, other financial organizations may be business concerns associated with the financial organization. For example, an insurance firm may be associated with a financial organization such as a bank. The system allows the users to interact among themselves through social networking websites and by utilizing other modes of communication. The system provides various Graphical User Interfaces (GUIs) and tools to each user to interact with other users of the financial organization or with their social groups and to perform one or more functionalities in an interactive environment. The functionalities may be associated with the financial organizations.

In an embodiment of the invention, each user may be associated with a financial organization for accessing a plurality of services associated with the financial organization. The users may be associated with the financial organization by creating a user profile with the financial organization. The profile may be created by a way of registration with the system. In an embodiment of the invention, the users may get registered with the financial organization by filling a typical online registration form available on the server of the system. The registration process may include providing association details of the users with respect to the financial organization. Thus, a user may be a customer, an employee, any other visitor to the system or the like. Using this information, the system will define privilege levels of the users to access various services. In another embodiment of the invention, some users may not be associated with the financial organization. Still, such users can access certain services in a limited and a predefined manner.

In an embodiment of the invention, the user may login into the system through various means to access various services. For example, the user may login into the system through the home page of the system by providing access credentials. A successful login may enable the user access all available services listed on the home page of the system. In another example, the user may access the system through other sources, e.g., the user may access the system from a social networking website such as Facebook. In accordance with another embodiment of the invention, the user may access one or more services without actually login into the system. For example, unregistered users may directly access limited services such as blogs and wikis through the system without actually logging in. This may facilitate unregistered users to avail a limited set of services of the financial organization.

The home page may provide various options to the user to perform operations, such as view, delete, modify, and similar functionalities on his/her profile. Further, the user may be facilitated to access one or more services associated with the financial organization and to perform various functionalities by utilizing the various options provided by the system. Each user may access the services based on his/her association level with the financial organization. In an embodiment, the association of the user may be defined based on the profile created by him/her.

The present invention provides an integrated system to implement a plurality of services associated with a financial organization. The services are implemented for a plurality of users. The system includes a linking module and a function module. The linking module associates user profiles corresponding to each of the plurality of users with the financial organization to enable the plurality of services for the users. The function module enables the users to perform a plurality of functionalities associated with the financial organization. Each of the users is enabled to perform the functionalities based on a type of user profile corresponding to the each of the users associated with the financial organization. Further, the function module includes a transaction module, an interaction module, and a social networking module. The transaction module enables the plurality of users to utilize one or more transaction services of the plurality of services. Similarly, the interaction module enables the plurality of users to utilize one or more interactive services, and the social networking module enables the plurality of users to utilize one or more social networking services of the plurality of services.

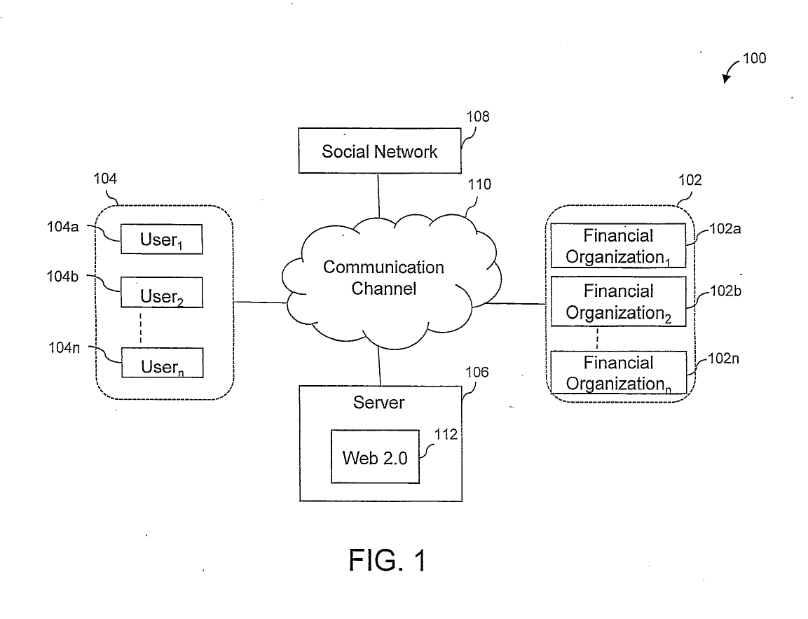

FIG. 1 illustrates an interactive environment 100 (hereinafter referred to as “environment 100”) in which various embodiments of the invention may be practiced. Environment 100 includes a plurality of financial institutions such as financial institution 102a, 102b, and . . . 102n (hereinafter referred to as “financial organizations 102”), a plurality of users such as users 104a, 104b, and . . . 104n (hereinafter referred to as “users 104”), a server 106, a social network 108, and a communication channel 110. The communication channel may include, but is not limited to, the Internet, mobile communication, advanced ATMs, and Kiosks. Server 106 may be a portal server or a non-portal server. Server 106 may include, but is not restricted to, features associated with Web 2.0 technology (represented as Web 2.0 112 in FIG. 1). These features may include, but are not restricted to, wikis, blogs, Really Simple Syndication feeds (RSS feed), various widgets, online discussion forums, and online demos. Financial organizations 102 may include, but is not restricted to, banks, investment firms, and insurance firms. Users 104 may be customers associated with financial organizations 102, employees of financial organizations 102, or other users directly or indirectly associated with financial organizations 102, and the like. In an embodiment, users 104 may also include other supporting financial organizations or a similar business concern that may be directly or indirectly associated with the financial organization. Social network 108 may include, but is not restricted to, unregistered users, such as members of one or more social groups, and one or more associated organizations.

Each of financial organizations 102 may be integrated with the features of Web 2.0 112 through server 106. Such features are implemented for financial organizations 102 to provide a plurality of services associated with their operations. The features are made accessible to users 104 by the means of communication channel 110, such as the Internet.

In an embodiment of the invention, users 104 are associated with financial organizations 102 by creating corresponding user profiles through a mode of registration with the financial organization. For example, the customers of financial organizations 102 may register by creating corresponding profiles with financial organization 102. Each user may access the services based on the association of the user with a financial organization, such as the financial organization 102a.

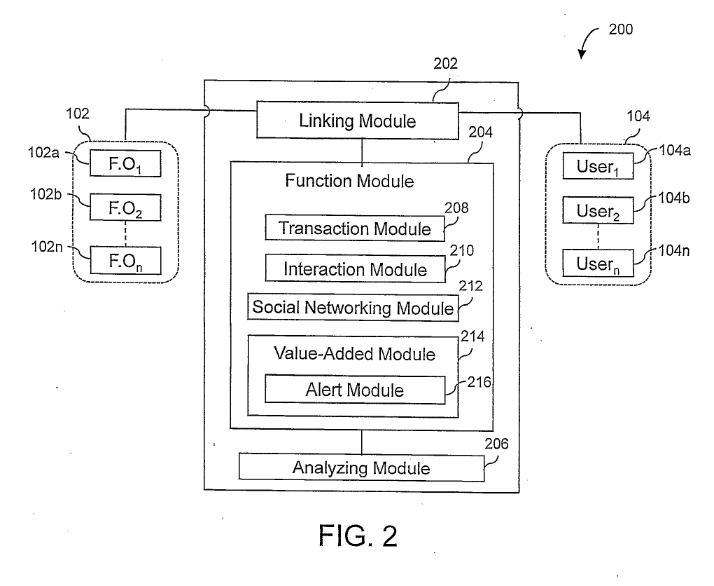

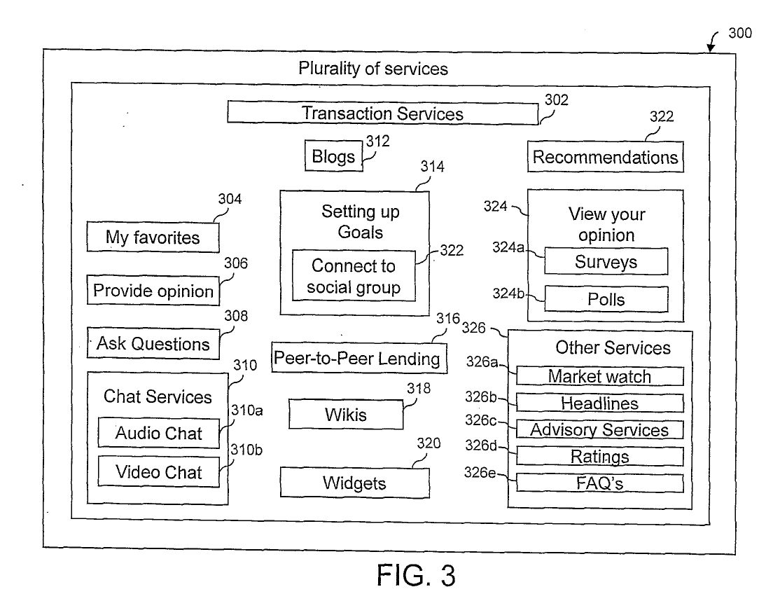

In one embodiment, users 104 who have registered as customers of the financial organization, may access most of the services, such as transaction services corresponding to the accounts of the users, interactive services, social networking services, and value-added services, offered by the financial organization (these services have been explained in detail in conjunction with FIGS. 2 and 3).

In another embodiment, users 104 may also include employees of the financial organization who may have registered as “employees of financial organization 102”. Such users may also be enabled to access the services, such as interactive services, social networking services, and value-added services.

In yet another embodiment, users 104 may choose to provide limited information while registering. This may however limit the access level for such users to only a predefined set of services from the available services of the financial organization. Such services may include providing information associated with the financial organization. For example, a user may wish to know about financial organizations 102 and various services/products offered by them. Financial organizations 102 may also provide services by which such users may resolve queries related to the organization and may plan and make various product-/services-related decisions accordingly. For example, the user may be facilitated to ask questions from employees of the banks, customers of the banks to get the latest information associated with the organization by utilizing corresponding services.

In an embodiment, users 104 may include representatives of one or more related organizations or associated business concerns of financial organizations 102. Such related organizations may be associated with the financial organization for providing combined benefits to one or more users of the financial organization. Such combined benefits may include specific services, such as an easy transaction to/from the financial organization from/to the related organizations, for users 104. For example, the related organizations may include other financial organizations, such as investment firms or insurance firms, which may enable users 104 to get benefitted directly from them. Users 104 may invest through the investment firms and the information corresponding to the investment made may be reflected in the account of users 104 associated with the financial organization, such as a bank. Also, users 104 may get additional benefits from the financial organization on dealing with the related organizations.

Based on the association of a user, the type of the user may be defined (hereinafter referred to as “user type”). Based on the user type, an access level may be defined for each user for accessing one or more of services associated with financial organizations 102. For example, a “customer” type user may be able to access all kinds of services available. Similarly, an “employee” type of user may also access most of the services and can act as a moderator for some services. Users, who are not the customers or employees of the financial organization, may be restricted to accessing limited services.

Users 104 and financial organizations 102 may interact with social network 108 through communication channel 110, such as the Internet, mobile communication, advanced ATMs, and Kiosks. In an embodiment, users 104 may interact with social network 108 by utilizing one or more features of Web 2.0 (shown as Web 2.0 112) while accessing one or more services associated with the financial organization. Social network 108 may include social groups of registered or unregistered users. Further, financial organizations 102 may interact with social network 108 to gain one or more opinion regarding various products and services associated with the financial organization.

It may be appreciated by any person skilled in the art that, in an embodiment, environment 100 may provide one or more direct means (not shown) for financial organizations 102 and users 104 to interact with social network 108 such as Facebook, Twitter, Orkut, and Linkedln. Due to this, financial organizations 102 and users 104 may interact with social network 108 without necessarily opting for corresponding services.

FIG. 2 illustrates a block diagram of a system 200 to implement a plurality of services associated with a financial organization, in accordance with an embodiment of the invention. System 200 includes a financial organization such as financial organization 102a (hereinafter referred to as “financial organization”) and users 104. Further, system 200 includes a linking module 202, a function module 204 communicably coupled to linking module 202, and an analyzing module 206 communicably coupled to function module 204. Function module 204 includes a transaction module 208, an interaction module 210, a social networking module 212, and a value-added module 214. Value-added module 214 includes an alert module 216.

Linking module 202 associates profiles of each of users 104 with the financial organization to enable users 104 to access services corresponding to the financial organization. Each user profile may be of a particular type based on the user's association with the financial organization. Linking module 202 also defines an access level for each of users 104 based on the type of user profile associated therewith. The access level defines the services associated with the financial organization available to users 104. For example, if a user is registered with the financial organization by submitting sufficient information, the user may be capable of accessing most of the services such as transaction-based services, interaction-based services, and social networking-based services. Alternatively, if the user submits limited information while registering with system 200 that may indicate a temporary relationship with the financial organization, the user may be able to access limited services based on the association of the user with the financial organization. Further, the access levels have been explained in conjunction with FIG. 1.

It may be apparent to any person skilled in the art that the access level for users 104 may be decided by the financial organization based on variety of factors, such as relationship of users 104 with the organization. In an embodiment, the relationship may be defined based on the information provided by users 104 while registering (for creating profile with the financial organization). Further, users' potentiality can also be determined by the financial organization based on the number of services opted by users 104.

Additionally, users 104 may include unregistered users such as members of one or more social groups. In an embodiment of the present invention, such unregistered users may not have profile associated with the financial organization. Further, the access level for such users may be less in comparison with other type of users (as described above). For example, the unregistered users may not access transaction services of the financial organization. Further, in an embodiment of the present invention, the services offerings for the unregistered users may be decided by the financial organization.

Function module 204 enables users 104 to perform various functionalities associated with financial organization. The user may perform the functionalities by utilizing various features of Web 2.0 tool (depicted by 112 in FIG. 1) integrated with financial organization. Further, each user may perform the plurality of functionalities based on the type of the user profile created by the user. For example, the user may access one or more services offered by financial organization such as transaction services, interactive services, social networking services, and value-added services.

Transaction module 208 enables users 104 to utilize one or more transaction services that are offered by financial organization. Transaction module 208 may provide various features to users 104 to offer the transaction services associated with the financial organization. Transaction services may include, but are not restricted to, one or more monetary services and one or more non-monetary transaction services.

Interaction module 210 enables users 104 to utilize one or more interactive services that may be offered by financial organization. Interaction module 210 may provide various features to users 104 to offer the interactive services that may allow users 104 to interact among themselves. For example, a user may be allowed to interact with other users and with representatives of financial organization. The interactive services may be utilized by users 104 to perform one or more functionalities. For example, interactive services may enable users 104 to interact with the representatives of financial organization to seek advice or to resolve queries corresponding to product(s)/service(s) associated with financial organization.

Interaction module 210 may allow one or more users to access interactive services such as providing ratings corresponding to one or more products and/or services offered by financial organization and taking part in various activities, such as polling, surveys, and opinions, associated with financial organization. Financial organization may analyze the ratings and polls provided by users 104 and draw insights accordingly. These insights can be used by financial organization for development or improvement of the products and/or services. Financial organization may also publish such ratings and polls for other users associated with financial organization. In an embodiment, the ratings may also be provided by unregistered users and one or more social groups which are not directly associated with financial organization. The ratings may be published or used for marketing purposes.

Social Networking Module 212 (hereinafter referred to as “SNM 212”) enables users 104 to utilize one or more social networking services associated with financial organization. Social networking services may allow users 104 to interact among themselves and with unregistered users. Unregistered users may include, but are not limited to, social groups from social networking websites such as Facebook, Twitter, Orkut, LinkedIn; an indigenous community; and other financial organizations such as financial organizations 102b . . . 102n.

SNM 212 may provide features to enable users 104 to set goals, peer-to-peer money lending, recommendations, and blogging. Such features enable users 104 to access social networking services and to perform functionalities corresponding thereto. For example, users 104 may set a monetary goal and share it among other known users and social groups to accomplish the same, borrowing or lending of finance, recommending one or more of the products and services, gathering information, clarifying queries corresponding to the products and services associated with financial organization, and the like. Social networking services may also enable financial organization to achieve viral marketing for their various products and services using various social groups of users 104.

The social networking services may enable financial organization to do a soft launch of their product(s) and/or service(s) for one or more communities of people. Each community of people may include, but is not limited to, one or more users and one or more social groups. Further, in an embodiment, the community may belong to a particular ethnicity. The financial organization may utilize such soft launch to test viability of the products and services by providing the products and services to a specific community of people. The products and/or service(s) may be provided to the community to know about the demand and prospects of the product(s) and/or service(s) in the community. Furthermore, members of the community may provide one or more opinions, corresponding to the product(s), and/or service(s). Based on this, the financial organization may develop an understanding about market requirements corresponding to the product(s) and/or service(s). Further, based on this, the financial organization may generate a report that may be utilized by the financial organization to take at least one strategic action.

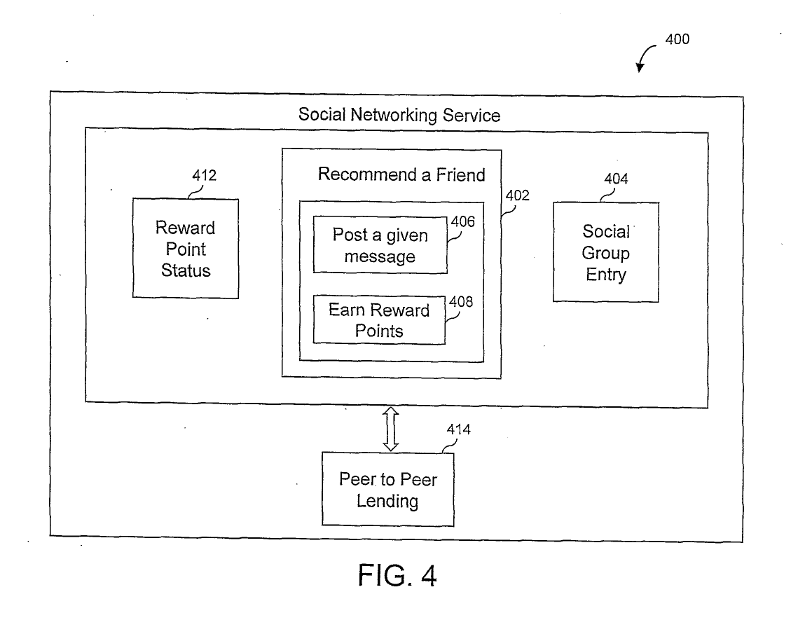

Value-added module 214 may enable users 104 to utilize one or more value-added services that may be offered by the financial organization. Value-added module 214 may enable users 104 to download widgets to one or more computational devices, such as personal computers, mobile phones, and PDAs, to view account balance, payments, bills, stock tickers, RSS feeds, and the like. Further, value-added module 214 may enable users 104 to utilize online demos and videos associated with the product(s) and/or service(s) of the financial organization. The online demos and videos may be utilized by users 104 to know about use and features associated with the product(s) and/or service(s). In an embodiment of the invention, such online demos and videos may promote the product(s) and/or service(s). Furthermore, alert module 216 of value-added module 214 may enable users 104 to receive alerts and rewards (incentives) corresponding to the functionalities performed by users 104 by utilizing services associated with the financial organization. The alerts may provide acknowledgment corresponding to the functionalities, such as recommending the product(s)/service(s) to members of a social group, performed by users 104. Further, the rewards may be provided, to users 104, by the financial organization for recommending the product(s)/service(s) to the members of the social group. The alerts and rewards are explained further in conjunction with FIG. 3 and FIG. 4. Additionally, alert module 216 may enable users 104 to receive RSS feeds corresponding to the financial organization.

Various functionalities performed by users 104 based on features and services provided to users 104 may be analyzed by analyzing module 206. Analyzing module 206 may analyze information gathered through function module 204. For example, analyzing module 206 may analyze one or more opinions, surveys, and polls corresponding to at least one of the products/services associated with the financial organization. In an embodiment, the opinions may be received from one or more communities. Also, analyzing module 206 may generate report based on the analyzed information. Based on the report, the financial organization may take strategic action(s) for development thereof. For example, analyzing module 206 may analyze the ratings, provided by the users, corresponding to different products and services offered by the financial organization. The strategic action(s) may be performed to enhance quality and/or features corresponding to the one or more products and services to meet expectations of users 104.

Similarly, analyzing module 206 may analyze functionalities, such as recommendations provided by users 104 for one or more products and services, performed by users 104. Such recommendations may enable viral marketing for one or more products and services associated with the financial organization. Further, analyzing module 206 may analyze such recommendations and enable the financial organization to provide reward to the users recommending the products and services. In an embodiment, the reward may include reward points that may be redeemable by the user.

It would be appreciated by any person skilled in the art that a secure online platform may be provided by system 200 to perform one or more functionalities, associated with the services, therein. Such online platform may enable users 104 to interact and transact among themselves safely without any threat to sensitive and confidential information. For example, a user may borrow, lend, transfer, or pay bills using the peer-to-peer or similar money lending services using the secure online platform.

Further, it would be appreciated by any person skilled in the art that the features and services (associated with the financial organization), provided by system 200, are not limited to the description above. Many other products/services may be offered by the financial organization through system 200 and thereby enable users 104 to perform one or more functionalities based on their association with the financial organization. The services associated with the financial organization are explained further in conjunction with description of FIG. 3 and FIG. 4.

FIG. 3 illustrates a block diagram for a plurality of services 300 associated with a financial organization, in accordance with an embodiment of the invention. Services 300 may include, but are not limited to, one or more transaction services 302, services associated with “my favorites” 304; “provide opinion” 306; “ask questions” 308; “chat services” 310 such as “audio chat” 310a and “video chat” 310b; “blogs” 312; “setting up goals” 314; “peer-to-peer lending” 316; “wikis” 318; “widgets” 320; “recommendations” 322; “voice your opinion” 324; and “other services” 326 such as “market watch” 326a, “headlines” 326b, “advisory services” 326c, “ratings” 326d, “FAQs” 326e, value-added services (not shown) such as online videos and demos. The services may be understood clearly in conjunction with description of FIG. 2.

Transaction services 302 may include, but are not limited to, money transfer; tax planning; credit/debit card-related transactions such as bill payment; loan-related transaction; services associated with other financial organizations; demand draft; and check transfer. Further, in an embodiment of the invention, transaction services 302 may include escrow services such as transfer of written agreement. Such transaction services 302 may enable users associated with a financial organization to perform one or more transactional functionalities. Such users need to be registered with the financial organization to access transaction services 302. The users may be registered with the financial organization by creating a user profile. The user may include, but is not limited to, a customer having an account associated with the financial organization and employees of the financial organization. The functionalities corresponding to transaction services 302 may include, but are not limited to, transferring money from one user account to another user account, payment for bills, transferring loan amount, transacting information and/or finance between the financial organization and one or more other financial organizations, and dealing with one or more representatives of the financial organization for financial planning such as tax planning.

“My favorites” 304 may enable users to perform one or more functionalities associated with the financial organization. Further, “My favorites” 304 enables the users to perform functionalities corresponding to their routine tasks such as payment of bills and e-recharge for mobile phone balance. In another embodiment, the one or more functionalities may include tasks of users' interest. Further, the users may perform the functionalities by utilizing their accounts associated with the financial organization. For example, “My favorites” 304 may enable users to send money in one or more associated accounts. This may enable users to send money to their family and friends. The users may transact money directly from their respective accounts (associated with the financial organization) to financial accounts of their family members.

Similarly, “My favorites” 304 may enable users to shop online, pay fees, and apply for loans, using their accounts associated with the financial organization.

“Provide opinion” 306 enables the users to provide their opinion about various products and services associated with the financial organization. For example, users may provide rating for the products and services associated with the financial organization. Further, the users may provide opinion through surveys and blogs. In an embodiment, the financial organization may utilize such opinions from the users to take strategic action corresponding to their products and services.

“Ask questions” 308 enables users to ask questions corresponding to financial planning, various products and services associated with the financial organization, and the like. The users may ask questions from one or more representatives of the financial organization. Accordingly, the representatives may provide solutions/answers to the users corresponding to their questions.

The users may find immediate solutions for their queries and seek suggestions by utilizing “chat services” 310. The users may be facilitated to chat to find answers/solutions for their queries from representatives of the financial organization, from one or more experts in a particular field associated with the services of the financial organization, one or more other users associated with the financial organization and the like. In an embodiment, “chat services” 310 may also allow users to chat with one or more third parties (such as unregistered users of the financial organization) to gain knowledge corresponding to the products and services associated with the financial organization. “Chat services” 310 may include “audio chat” 310a and “video chat” 310b.

Further services 300 may provide capability of blogging through “blogs” 312. The users may share their viewpoints on various topics associated with the financial organization. For example, the users may share tips and tricks corresponding to share trading. Also, “blogs” 312 may enable the users to read the content written by other users, to write and edit their own viewpoint corresponding to the topics. Further, “blogs” 312 may allow the users to add a new topic to the blog or create a new blog.

The users may set up one or more monetary goals through “goals” 314. Through these monetary goals, a user can invite money contribution from friends, family, and social groups. For example, a user may invite his/her family members to contribute toward paying his tuition fees. The users may be provided with a feature to connect to a social group to invite such individuals. For example, the users may connect to the social group through an exemplary tab depicted as “connect to social group” 328. Friends and family may transfer money from their financial accounts to the account of the user (associated with the financial organization). The financial accounts of the friends and the family may or may not be associated with the financial organization.

Additionally, the users may view the amount contributed by each individual. Also, the users are capable of viewing their previously set goals.

Similarly, services 300 may include “peer-to-peer lending” 316 to enable the users to borrow/lend money from/to one or more individuals. For example, a user may borrow money from another user of the financial organization. It may be understood by a person skilled in the art that the “peer-to-peer lending” between the users and other monetary/non-monetary transactions may be moderated by the respective financial organizations.

The users may be provided “wikis” 318, or other similar knowledge sharing platforms to share knowledge. Further, “wikis” 318 may be utilized for internal functioning of the financial organization. For this, the users (customers or employees) may utilize wikis to share their knowledge corresponding to the products and/or services associated with the financial organization. Wikis can be useful to present information on various products and services and their past performance. For example, a mutual fund company can create a page on the product which users can buy and can showcase the type of companies being invested in, the returns which were given in past years and other related information.

“Widgets” 320 enables the users to download one or more widgets on their personal computers or mobile devices for accessing one or more services associated with the financial organization. For example, a user may download widgets to view available balance in the user's account associated with the financial organization. Further, the user may view payments made by the user through the account, receive stock and news alerts, and the like.

Additionally, services 300 may include a social networking service such as “recommendations” 322. Using this, the users may be facilitated to recommend one or more products and/or services associated with the financial organization to one or more third parties such as members of social groups. Further, the users may be facilitated to post a message on the social groups. For this, the users may be provided with option/links to make an entry into the one or more social groups' Web page. For instance, a user may wish to recommend a particular service associated with the financial organization to a social group. The user may enter into a social networking website, such as Facebook, to post a message corresponding to the service. The message may be posted to recommend the service to the one or more members within the social group. This service thus enables the financial organization to achieve viral marketing for its products and services.

The user may receive an acknowledgement for posting the message on such social networking websites. In an embodiment of the invention, the user may receive an incentive from the financial organization for recommending the services. Further, in an embodiment, the incentive may include value points that may be redeemable by the user. The social networking service is further explained in conjunction with FIG. 4.

Financial organizations may conduct surveys, depicted by tab “survey” 324a, and/or create polls, depicted by tab “polls” 324b, to receive inputs from the users. Similarly, “voice your opinion” 324 may enable the users to vote for the created polls and participate in surveys. The users' votes and opinions may be used by the financial organizations to make decisions corresponding to the created polls and conducted surveys.

The users may be provided with “other services” 326. “Other services” 326 may include, but are not limited to, “market watch” 326a, “headlines” 326b, “advisory services” 326c, “ratings” 326d, and “FAQs” 326e. The users may use “market watch” 326a to provide business news, analysis, and stock market data; “headlines” 325b may provide news alerts to the users. Similarly, “advisory services” 325c may provide various tips to the users. Such tips may enable the users to perform improved financial planning/decision making/query resolution. “Ratings” 326d may allow the users to rate one or more products and services associated with the financial organization. “FAQs” 326e may enable the users to find answers for frequently asked questions.

It may be appreciated by any person skilled in the art that services 300 associated with the financial organization are not limited to services mentioned above. The financial organization may provide numerous other services to the users that may include, but are not limited to, online demos and videos associated with one or more services/products associated with the financial organization, mashups, tagging, trackback, and social bookmarking. Further, it may be appreciated that services 300 may be classified in one or more category such as transaction services, interactive services, social networking services, and value-added services. Additionally, it would be apparent to one skilled in the art that the financial organization may add many more features for providing various other services which help the users to effectively manage their accounts and relationships with various financial organizations.

FIG. 4 illustrates a block diagram 400 for social networking services, in accordance with an exemplary embodiment of the invention. Social networking services depicted in FIG. 4 corresponds to providing recommendations to users about one or more services and/or products associated with a financial organization. Here, the users may also include members of the social group(s). Further, FIG. 4 depicts a social networking service corresponding to peer-to-peer lending, depicted as 414, for facilitating the user to lend/borrow money to/from one or more individuals. The one or more individuals may include members of the social group(s). In an embodiment, the users may lend/borrow money to/from one or more members of a social group by login into their social networks. The users may login to their social networks directly through system 200. The users can then provide recommendations to one or more social contacts or social groups using a tab “recommend a friend” 402.

Thus, the users associated with the financial organization may be facilitated to enter into the social group to post a message for recommending the one or more services and/or products associated with the financial organization. For this, the users may be provided with an option, such as “social group entry” 404, to enter into the social group. For example, “social group entry” 404 may allow the user to login into his/her account associated with Facebook to post messages. Further, “post a given message” 406 may provide a message to the user that may be posted to the social group or one or more social contacts.

The message may be associated with the one or more services and/or products and updates associated with the financial organization. For example, the message may include details pertaining to the rates associated with home loans, interest rate offered by the financial organization, registration charges for any new scheme, or a new offer associated with the financial organization.

In an embodiment of the invention, the user may receive an incentive (depicted by “earn reward points” 408) on successfully recommending the one or more services and/or products to the individuals. The incentive will be provided by the financial organization. In an embodiment, the incentive in the form of reward points may be credited to the user's account associated with the financial organization. Additionally, “reward point status” 412 may be provided to the user for displaying the status of the earned incentive/reward points.

Additionally, the user may be provided with an option, such as “peer-to-peer lending” 414 for facilitating the users to lend/borrow money to/from one or more individuals. The users may enter into a social group through “social group entry” 404 to interact with members of the social group for lending/borrowing money thereto/therefrom. Further, the users may be provided with various means for initiating money transfer for lending/borrowing to/from the one or more individuals. Some examples of such means, using which users can transfer money, may include, but are not limited to, providing account numbers of the users, or E-mail addresses, or phone/mobile numbers, or other similar information which can uniquely identify the person to whom money needs to be transferred.

The invention as described above has numerous advantages. The invention provides an integrated system with numerous services for users. Further, various embodiments of the present invention may be utilized to provide various features/options associated with the services to enable the users to utilize the services. One or more users may be facilitated to utilize the services (and/or product(s) associated with the financial organization) to perform one or more functionalities for their benefits. Further, users may be facilitated to interact with family, friends, and one or more members of a social network. Further, the users may interact among themselves, with their friends and other people associated with the financial organization and may, further, clarify their queries associated with the financial organization and corresponding to the product(s) and/or service(s). For example, each registered user may ask his/her family/friends for contribution toward various goals of the users.

Further, the invention enables the users to interact with third parties through the social network to share views and gain information associated with the financial organization. This further enables the users to confirm about the products/services from the third parties before actually opting for them. This helps the users to take a sound judgment before making a decision or investment corresponding to the financial organization.

The user may access the latest information and various features corresponding to dealing with the financial organization on a single Web page. Thus, this may enable the user to remain aware and active about the current offers provide by the financial organization. Also, this may enable the user to plan for his/her financial matters effectively. Moreover, the invention provides a secure platform for various transactions with the financial organization, the users associated with the financial organization and with third parties. For example, the user may safely utilize a social networking service such as peer-to peer borrowing/lending money under this secured platform. This provision may allow the users to perform transactions without any fear of leaking of information.

Additionally, the invention may attract the users and gain their loyalty toward the financial organization through various ways. For example, reward points may be provided to the users for recommending one or more services/products associated with the financial organization. This may enable the financial institution to build better relationship with their customers. Additionally, the financial organization may be benefitted through such recommendations. For example, the financial organization may become more visible in the market and may earn a brand value for the associated one or more services/products. Thus, this may directly/indirectly enhance viral marketing for the one or more services/products associated with the financial organization.

Also, the invention may enable the financial organization for a soft launch to gain opinion on the one or more services/products from a particular social group. This may enable the financial organization to know more about liking, disliking, and demand of the one or more services/products among the social group. Further, this may enable the financial organization to take strategic actions for promotion and other benefits of the financial organization as a whole.

The invention allows many other financial organizations and SME customers to contact the financial organization through the social network for proposing new business ideas to the financial organization for the support of their business venture. Thus, this may lead to further growth of the financial organization.

It may be appreciated by any person skilled in the art that the present invention is not limited to various advantages as mentioned above. The present invention may facilitate the users with various other features for performing one or more functionalities and for taking at least one strategic action. Furthermore, the system of the present invention allows the users to utilize his/her choice of embodiments/features of the present invention in an optimal way and with minimum time and effort requirements.

The system for financial organization(s), as described in the present invention or any of its components, may be embodied in the form of a computer system. Typical examples of a computer system include a general-purpose computer, a programmed microprocessor, a micro-controller, a peripheral integrated circuit element, and other devices or arrangements of devices that are capable of implementing a plurality of services associated with the financial organization(s).

The computer system comprises a computer, an input device, a display unit, and the Internet. The computer further comprises a microprocessor, which is connected to a communication bus. The computer also includes a memory, which may include Random Access Memory (RAM) and Read Only Memory (ROM). The computer system also comprises a storage device, which can be a hard disk drive or a removable storage drive such as a floppy disk drive and an optical disk drive. The storage device can also be other similar means for loading computer programs or other instructions into the computer system. The computer system also includes a communication unit, which enables the computer to connect to other databases and the Internet through an Input/Output (I/O) interface. The communication unit also enables the transfer and reception of data from other databases. The communication unit may include a modem, an Ethernet card, or any similar device which enable the computer system to connect to databases and networks such as Local Area Network (LAN), Metropolitan Area Network (MAN), Wide Area Network (WAN), and the Internet. The computer system facilitates inputs from a user through an input device, accessible to the system through an I/O interface.

The computer system executes a set of instructions that are stored in one or more storage elements to process the input data. The storage elements may also hold data or other information as desired. The storage element may be in the form of an information source or a physical memory element present in the processing machine.

The present invention may also be embodied in a computer program product for facilitating a user associated with the financial organization to perform one or more functionalities corresponding to various services/products offered by the financial organization. The computer program product may include a computer-usable medium having a set program instructions, comprising a program code for facilitating the user to utilize one or more services associated with the financial organization. The set of instructions may include various commands that instruct the processing machine to perform specific tasks such as tasks corresponding to one or more functionalities of the user while utilizing the one or more services. The set of instructions may be in the form of a software program. Further, the software may be in the form of a collection of separate programs, a program module with a large program or a portion of a program module, as in the present invention. The software may also include modular programming in the form of object-oriented programming. The processing of input data by the processing machine may be in response to user commands, results of previous processing, or a request made by another processing machine.

While the preferred embodiments of the invention have been illustrated and described, it will be clear that the invention is not limit to these embodiments only. Numerous modifications, changes, variations, substitutions, and equivalents will be apparent to those skilled in the art without departing from the spirit and scope of the invention, as described in the claims.

What is claimed is:

1. A system for implementing a plurality of services associated with a financial organization, the plurality of services being implemented for a plurality of users, the system comprising:
a. a linking module configured for associating user profiles corresponding to each of the plurality of users with the financial organization for enabling the plurality of services for the plurality of users;
b. a function module configured for enabling the plurality of users to perform a plurality of functionalities associated with the financial organization, each of the plurality of users being enabled to perform the plurality of functionalities based on a type of user profile corresponding to the each of the plurality of users associated with the financial organization, the function module comprising:
i. a transaction module configured for enabling the plurality of users to utilize one or more transaction services of the plurality of services;
ii. an interaction module configured for enabling the plurality of users to utilize one or more interactive services of the plurality of services; and
iii. a social networking module configured for enabling the plurality of users to utilize one or more social networking services of the plurality of services.

2. The system of claim 1, wherein the linking module is further configured to define an access level for each of the plurality of users based on the type of user profile of each of the plurality of users.

3. The system of claim 1, wherein the interaction module enables interaction among the plurality of users.

4. The system of claim 1, wherein the interaction module enables the plurality of users for participating in at least one of polling and online surveys.

5. The system of claim 1, wherein the interaction module enables one or more of the plurality of users to provide at least one of ratings and reviews corresponding to at least one of the plurality of services associated with the financial organization.

6. The system of claim 1, wherein the social networking module enables interaction between the plurality of users and unregistered users.

7. The system of claim 1, wherein the plurality of users utilize the one or more social networking services for performing at least one of:
a. gathering information associated with the financial organization;
b. recommending at least one of the plurality of services associated with the financial organization;
c. clarifying one or more queries associated with at least one of the plurality of services associated with the financial organization;
d. peer-to-peer money lending by utilizing a secure online platform; and
e. setting up one or more financial goals, the one or more financial goals being sharable among the plurality of users and one or more social groups.

8. The system of claim 7, wherein the information is gathered by utilizing at least one of blogs and integrated wikis associated with the financial organization.

9. The system of claim 1 further comprising an analyzing module configured for analyzing information gathered through the function module, the information being gathered based on the plurality of functionalities.

10. The system of claim 9, wherein the analyzing module is further configured to generate a report based on the analyzed information.

11. The system of claim 10, wherein the analyzing module enables the financial organization to take at least one strategic action, the at least one strategic action performed based on the report.

12. The system of claim 1, wherein the function module further comprises a value-added module for enabling one or more of the plurality of users to utilize one or more value-added services of the plurality of services.

13. The system of claim 12, wherein the value-added module enables one or more of the plurality of users to utilize one or more widgets associated with the financial organization.

14. The system of claim 12, wherein the value-added module enables one or more of the plurality of the users to provide at least one of online demos and videos corresponding to at least one of the plurality of services associated with the financial organization.

15. The system of claim 12, wherein the value-added module comprises an alert module for providing Really Simple Syndication feeds (RSS feeds) and alerts to the plurality of users.

16. The system of claim 1 further comprising an analyzing module configured for analyzing online social behavior of the users.
